(19) United States
(12) Patent Application Publication
(10) Pub. No.: US 2025/0074234 A1
(43) Pub. Date: Mar. 6, 2025

(54) CHARGING DEVICE FOR CHARGING AN ELECTRIC VEHICLE

(71) Applicant: Siemens Aktiengesellschaft, München (DE)

(72) Inventors: Johannes Richter, Fürth (DE); Stefan Perras, Eichenau (DE); Peter Kummeth, Herzogenaurach (DE)

(21) Appl. No.: 18/822,701

(22) Filed: Sep. 3, 2024

(30) Foreign Application Priority Data
Aug. 31, 2023 (DE) 10 2023 208 393.0

(51) Int. Cl. B60L 53/35; B60L 53/18; B60L 53/302; H02G 11/00

(52) U.S. Cl. CPC B60L 53/35; B60L 53/18; B60L 53/302; H02G 11/006

(57) ABSTRACT

A charging device for charging an electric vehicle with electrical energy includes a charging cable which is able to be connected to a charging connector on the electric vehicle to be charged. The charging device has a drag chain assembly which is configured to transport a set of cables flexibly in the direction of the charging connector in at least one spatial direction and to co-align it with the charging connector of the electric vehicle.

### CROSS-REFERENCE TO RELATED APPLICATION

This application claims the priority, under 35 U.S.C. § 119, of German Patent Application DE 10 2023 208 393.0, filed Aug. 31, 2023; the prior application is herewith incorporated by reference in its entirety.

### FIELD AND BACKGROUND OF THE INVENTION

The invention relates to a charging device for charging an electric vehicle with electrical energy by using a charging cable which is able to be connected to the electric vehicle to be charged.

Electric vehicles (also known as electrically powered vehicles) are increasingly replacing motor vehicles with internal combustion engines. It is to be expected that not only the number of electric vehicles with drivers will increase in the future, but also the number of autonomously driving electric vehicles. The first applications will be, for example, autonomously driving taxi and shuttle vehicles. The utilization of those autonomous vehicles is a decisive factor for the profitability of the services, so that downtimes for recharging must be minimized as far as possible. That is done by using appropriate rapid charging stations using direct current or optionally alternating current. Since there may be no longer a driver in the autonomous vehicles who can carry out the charging process manually, such as plugging in and unplugging the charging cable, an autonomous fast charging device is required.

### SUMMARY OF THE INVENTION

It is accordingly an object of the invention to provide an improved charging device for charging an electric vehicle, which overcomes the hereinafore-mentioned disadvantages of the heretofore-known devices of this general type and which is provided, in particular, for charging an autonomously driving, electric vehicle.

With the foregoing and other objects in view there is provided, in accordance with the invention, a charging device for charging an electric vehicle with electrical energy by using a charging cable which is able to be connected to a charging connector on the electric vehicle to be charged, and a drag chain assembly which is specified to move or transport a set of cables, in particular at least one charge transmission cable and/or the charging cable, flexibly in the direction of the charging connector in at least one spatial direction (also called the transporting direction) and co-align it with the charging connector of the electric vehicle.

Advantageous structural embodiments of the invention are the subject matter of the dependent claims.

The set of cables, in particular the charge transmission cable and/or the charging cable with a charging plug, can be moved or transported flexibly in the at least one spatial direction, in particular a longitudinal direction, over a corresponding length or a corresponding distance to the charging connector by such a charging device.

A charging device is understood to mean in particular an autonomous charging device or an autonomous charging station, for example a quick charging station. The charging station can be connected to a mains supply, on the one hand, and to the charging cable, on the other hand. For automatically connecting and releasing the charging plug to and from the charging connector on the electric vehicle, the charging station is configured so as to be adjustable in at least one, preferably in two, three or a plurality of spatial directions. The charging device can be operated autonomously without a person to automatically insert the charging plug into the electric vehicle to be charged and to remove the charging plug from the latter.

The charging device is optimized in terms of installation space and electrical losses as well as costs. A charging plug disposed on one end of the charging cable can be automatically moved to the position of the charging connector of the electric vehicle and thereon be co-aligned with the charging connector and plugged into the charging connector, in particular a charging plug socket.

After the charging process has been completed, the charging plug can be automatically extracted or removed from the charging connector again by using the charging device. The charging device can be used universally for various electric vehicles, because the charging cable with the charging plug can be transported to the respective, non-standardized position for the charging connector on electric vehicles. In other words: The charging device is suitable for different types of vehicles with different charging connector positions.

The charging cable is configured in particular for charging the electric vehicle with direct current. The charging cable is preferably configured for charging the electric vehicle with direct current or optionally alternating current at a charging current of, for example, at least 125 A, in particular in a range of a few hundred amperes up to one or several thousand amperes, and/or a charging voltage of at least 125 V, in particular in a range of 230 V up to several thousand volts.

In a potential embodiment, the drag chain assembly can be specified to receive, to guide and to move as a set of cables—in addition to the charge transmission cable (also called power cable) and/or the charging cable—electrical auxiliary lines, such as, for example, at least one control line, a signal line, a test line, a power line, a cooling line, a supply line or the like. In other words: The set of cables can be configured as a power supply kit including charging cables, charge transmission cables, signal lines, control lines, power lines, test lines and/or cooling lines.

In a potential embodiment, the drag chain assembly can be specified to guide and move the set of cables in a plurality of, in particular two or three, spatial directions or transporting directions.

For example, the set of cables, in particular the charging cable, can be transported horizontally in the longitudinal direction, in particular toward the front and the rear, and/or horizontally in the transverse direction, in particular back and forth perpendicularly to the longitudinal direction, and/or vertically in the vertical direction, in particular toward the top and the bottom. This allows a charging plug disposed on the end of the charging cable to be moved and/or aligned to any position. The charging device is thus specified and suitable for correct and safe coupling of the charging plug to charging connectors of various electric vehicles.

Another embodiment provides that the drag chain assembly includes at least one drag chain and at least one plug bracket. The drag chain is used in particular to guide the cable set, in particular the charge transmission cable, the charging cable and/or the auxiliary lines. The drag chain may, for example, be formed as a drag hollow section, in particular a drag duct.

The set of cables can or may be routed continuously by way of a plurality of drag chain units. The plurality of drag chain units can also be disposed at a mutual spacing in a continuous routing of the cable set in the longitudinal extent of the cable set.

Additionally or alternatively, the cable set can be of a modular construction. For example, the cable set can have a plurality of cable portions, in particular one cable portion per drag chain unit. For example, two cable portions between two drag chain units can be coupled to one other by way of a plug connection.

Additionally, the respective drag chain unit can be specified in such a way that the cable set is linearly guided. Alternatively, the respective drag chain unit can be specified in such a manner that the cable set is guided in a plurality of spatial directions, in particular three-dimensionally. For example, the cable set can be deflected by 180° in the transition region between two drag chains. Due to such a three-dimensionally guided drag chain, an actuating movement of the charging device for the charging plug can simultaneously cover a plurality of spatial directions.

The plug bracket (also called gripper for short) can be configured, for example, as a gripping arm, a gripping hook or an entrainment hook.

For example, the charging device can include one associated drag chain per spatial direction or transporting direction. In addition, the charging device can be connected to the charging plug at one of the ends of the cable set. At the opposite end, the cable set is connected to a supply connector or power connector, in particular a ground terminal, of a nearby or remote charging station.

The charging plug, in turn, can be rigidly or releasably disposed on the plug bracket. Alternatively, the drag chain(s) and/or the plug bracket can be specified to entrain and move the set of cables in all spatial directions.

Moreover, the drag chain assembly can be able to be driven and moved by using at least one drive assembly. For example, the drive assembly can include one associated drive unit, for example a motor, in particular an electric motor or the like, per drag chain.

The respective drive unit is coupled, in particular operatively coupled for motion, to an adjustment device, for example linear actuators, angle actuators, rotary joints and/or ball joints. By actuating the adjustment device, in particular the linear actuators, angle actuators, rotary joints and/or ball joints, the plug bracket can follow the charging plug and its position during a charging process (also referred to as fine adjustment, which is provided for following a movement of the plugged charging plug during charging of the electric vehicle).

Alternatively or additionally, before a charging operation the plug bracket can be moved by using the adjustment device in the direction of the charging connector and co-aligned with the charging connector (also referred to as coarse adjustment, which is provided for finding the non-standardized position of the charging connector on the electric vehicle). The angular position of the charging plug can be co-aligned with the charging connector by using separate actuators, in particular angle actuators.

Furthermore, after a charging operation the plug bracket can be moved by using the adjustment device in the direction of the charging plug to its receiving position and moved away from the charging connector to release the charging plug (also called actuating movement).

In order to adjust the plug bracket with or without a fixed charging plug, the plug bracket can be disposed on and fastened to a movable unit of the adjustment device. Optionally, the plug bracket per se can be movably mounted.

The drive assembly can also be configured as a linear drive, for example. In particular, the linear drive can include a linear adjustment unit (for example, base unit/stationary rail and carriage/movable rail) and a drive unit. The linear adjustment unit can, for example, include a stationary unit, in particular a stationary rail or stationary support unit, and a movable unit, in particular a movable carriage (also called a mobile carriage) or a movable rail, which is movable relative to the stationary unit. The drive unit is configured in particular as a motor which is coupled to the movable unit so as to move the latter along the stationary unit. Moreover, the charging device can include at least one linear drive per spatial direction. For example, the charging device includes at least one linear drive for a longitudinal movement, in particular for a large adjustment length along a longitudinal side of the electric vehicle, at least one linear drive for a transverse movement, in particular perpendicular to the longitudinal movement, for example, an actuating movement in the region of the charging connector, and/or at least one linear drive for a vertical movement, in particular an upward movement relative to the longitudinal movement and/or transverse movement, for example an actuating movement in the region of the charging connector.

In a further embodiment, the respective drag chain is disposed parallel to the respective adjustment device, in particular a linear adjustment unit. For example, the respective drag chain is fastened to the stationary unit on one side and to the portable unit on the other so as to be entrained.

Another optional embodiment provides that the drag chain assembly is specified to cool the set of cables, in particular the charging cable and a charging plug which is provided at the end of the charging cable. In particular, when the charging device is conceived as a high-performance charging device with a permanent charging power of, for example, 200 A or greater up to several thousand amperes, the drag chain assembly includes a cooling element, in particular one or more cooling line/s, for example, in each case one or a plurality of infeed cooling lines and return cooling lines, for cooling the charging cable and/or the charging plug.

Moreover, the drag chain can include a plurality of drag chains, in particular at least one drag chain per spatial direction. The respective drag chain can be configured to be flexible and deflectable. In particular, the respective drag chain is configured to be flexibly deflectable along a longitudinal line.

In a potential refinement, the respective drag chain can be configured as a flexible hollow section support in which the cable set, in particular the charge transmission cable, the charging cable and/or the ancillary lines, at least over a part of its length or their lengths and/or in portions, is received inside the hollow section support. Additionally, the hollow section support, in particular for each drag chain unit, can be provided at one or both ends with a strain relief unit for the respective charge transmission cable, the charging cable and/or the ancillary lines. In other words: The entire cable set is strain-relieved by the strain relief units at the input and output of the respective drag chain unit. The flexible hollow section support can be configured, for example, so as to be open, semi-open or closed.

Moreover, the cable set, in particular the charge transmission cable, the charging cable and/or the auxiliary lines, can be guided without drag chains in a transition between two spatial directions. Optionally, an additional simple protection can be provided in the transition by guiding the cable set in a flexible corrugated tube, flexible corrugated hose or the like.

In a potential embodiment, the cable set, in particular the charge transmission cable(s) and/or the charging cable or the respective cable, can include a plurality of stranded copper wires. In particular, the respective cable or the respective line can include a plurality of flexible stranded copper wires. The charge transmission cable and/or the power transport line can each include a plurality of stranded copper wires or copper flat lines having a larger cross section or circumference than the stranded copper wires of the charging cable. In particular, the stranded copper wires can be configured as flexible individual lines. As a result of such a configuration, the charge transmission cables can be guided without cooling and with low loss by using the drag chain assembly. Only the region of the charging cable with the smaller cross section or circumference, and/or the charging plug, may be cooled.

Due to the configuration of the charge transmission cable or the charging cable in each case as a plurality of flexible strands, in particular stranded copper wires, the installation space for the drag chain assembly movable in at least three spatial directions can be minimized. Moreover, the plurality of highly flexible strands per electrical connection of the cable set enable low electrical losses. The overall cable cross section can also be flexibly adapted to the output class of the autonomous charging device by the number of highly flexible strands used per electrical connection of the cable set and their cross section. A stranded wire is understood to mean in particular an electrical conductor which is formed of thin individual wires and thus easy to bend.

Furthermore, the set of cables can be fastened by way of at least one strain relief element to at least one end of the respective drag chain. For example, a first end of the cable set, in particular of the respective cable, engages on a supply line, in particular a connecting line, for example, an earth line or a ground rail, of a charging station by way of a first strain relief element of the drag chain. At an opposite second end of the cable set, the respective cable engages on the charging plug by way of a second strain relief element. The ends of the cable set, in particular of each cable or line, can engage on the charging station and/or the charging plug in a fixed manner, or by way of a plug connection.

In addition, the respective drag chain can include at least one guide for the set of cables. For example, separating webs with and without height separation, cable duct portions, cable feedthroughs, cable trays, cable grooves or the like can be provided.

Other features which are considered as characteristic for the invention are set forth in the appended claims.

Although the invention is illustrated and described herein as embodied in a charging device for charging an electric vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, rear-elevational view of an electric vehicle at a charging device according to the invention;

FIG. 2 is a perspective view of a first exemplary embodiment of the charging device according to the invention shown in FIG. 1;

FIG. 3 is a perspective view of the charging device according to the invention shown in FIG. 1, in a first end position;

FIG. 4 is a perspective view of the charging device according to the invention shown in FIG. 1, in a second end position;

FIG. 5 is a perspective view of a second exemplary embodiment of a charging device according to the invention;

FIG. 6 is a top-plan view of the charging device according to the invention shown in FIG. 5; and

FIG. 7 is a lateral, perspective view of the charging device according to the invention shown in FIG. 5.

### DETAILED DESCRIPTION OF THE INVENTION

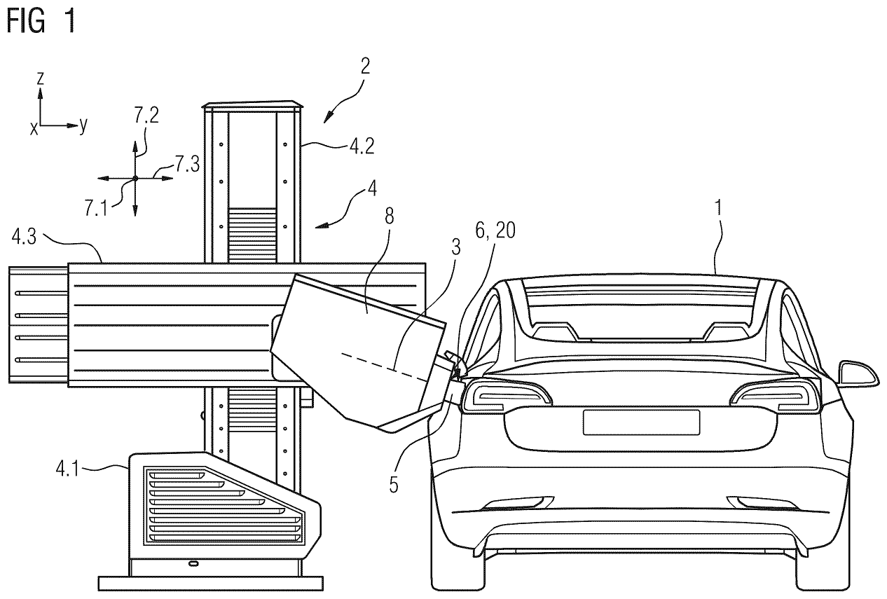

Referring now in detail to the figures of the drawings, in which mutually equivalent parts are provided with the same reference signs, and first, particularly, to FIG. 1 thereof, there is seen an electric vehicle 1 at a charging device 2 according to the invention, in a view from the rear.

The charging device 2 is configured as an autonomous charging station for charging the electric vehicle 1. The electric vehicle 1 is, for example, an autonomously driving vehicle, which automatically approaches the charging device 2 for charging.

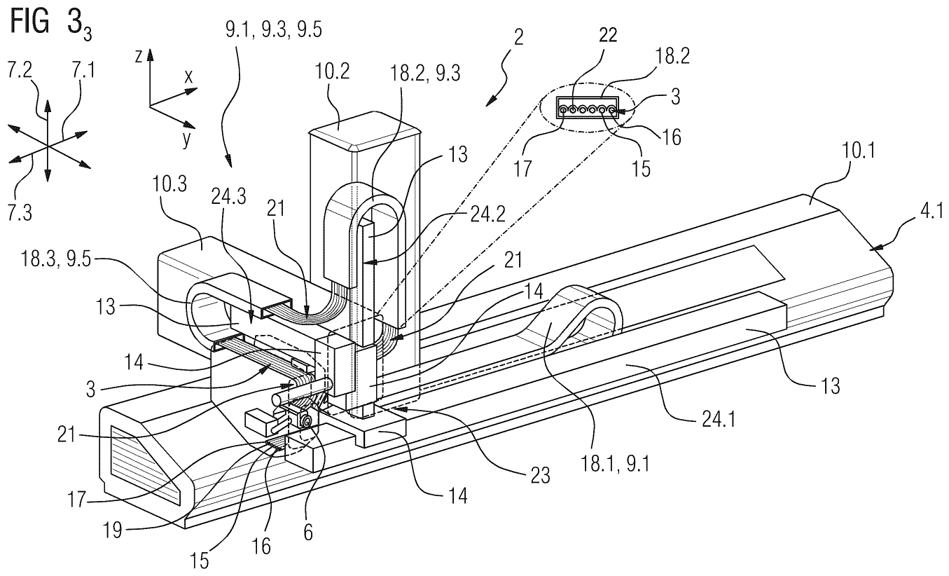

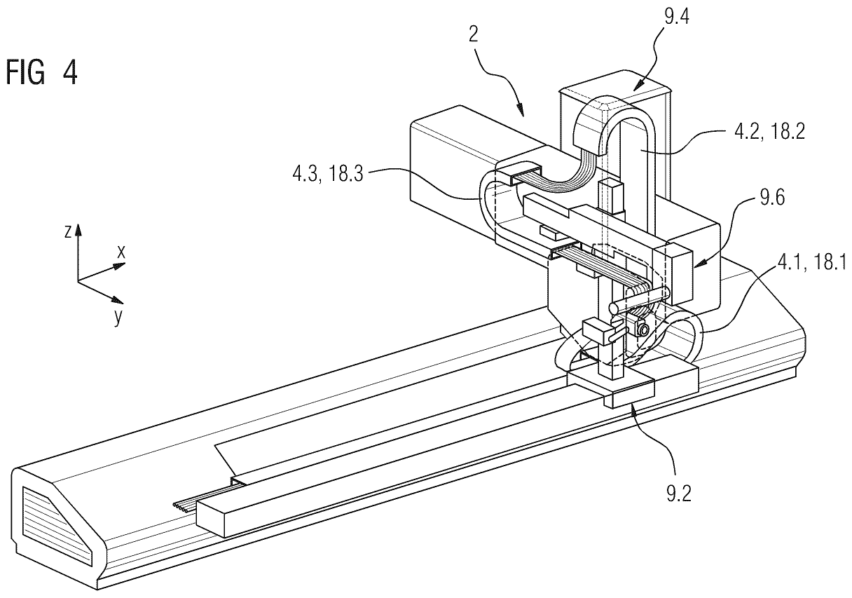

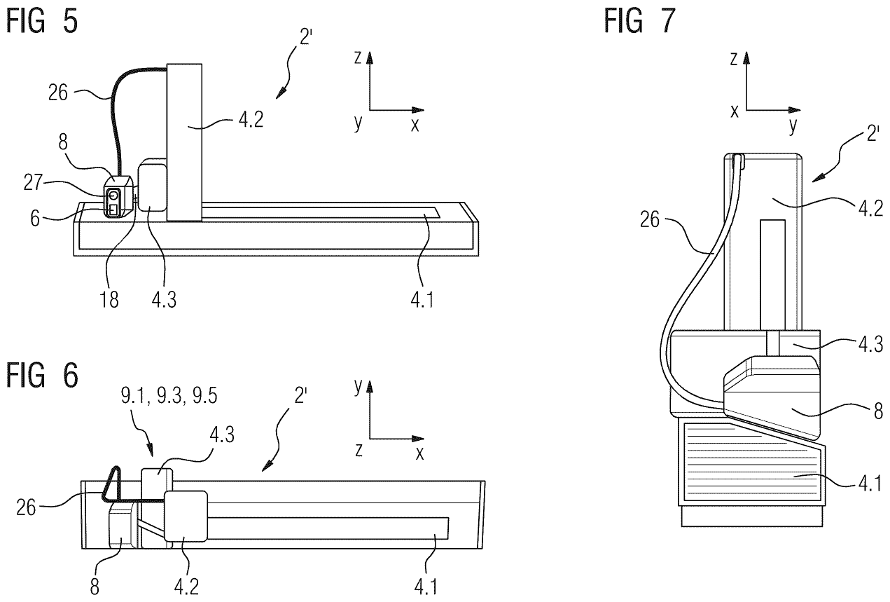

The charging device 2, in particular the autonomous charging station, for flexibly offering up a set of cables 3 (hereinafter referred to as a cable set 3 for short) from a supply connection or power connection which is not illustrated, in particular an earth connection, of a near or distant charging station (not illustrated in more detail) to a charging connector 5 of the electric vehicle 1, includes a drag chain assembly 4 which according to a first exemplary embodiment is shown and described in more detail in FIGS. 3 and 4, and according to a second exemplary embodiment in FIGS. 5 to 7.

The charging device 2 with the drag chain assembly 4 is configured as a robotic charger through the use of which a plug bracket 8 disposed on the drag chain assembly 4 can be moved variably, in particular in a plurality of spatial directions 7.1 to 7.3, in the direction of the charging connector 5 and/or be co-aligned with the charging connector 5.

The electric vehicle 1 includes, as the charging connector 5, a charging plug socket, for example. The cable set 3, on its end facing the electric vehicle 1, has a charging plug 6 which is configured for coupling to the charging connector 5.

The drag chain assembly 4 (also referred to as cable routing assembly) is in particular configured to move or transport the cable set 3 flexibly in the direction of the charging connector 5 in at least one spatial direction 7.1 to 7.3 (also called the transporting direction) and to co-align it with the charging connector 5 of the electric vehicle 1.

Due to such a charging device 2, the cable set 3 can be flexibly moved or transported in a first spatial direction 7.1 in the longitudinal direction x, in a second spatial direction 7.2 in the transverse direction y and/or in a third spatial direction 7.3 in the vertical direction z over a corresponding length or a corresponding distance to the charging connector 5 of the electric vehicle 1 that has autonomously approached the charging device 2.

The charging device 2 is specified in such a way that the charging plug 6 disposed on the end of the cable set 3 is automatically moved to the position of the charging connector 5 of the electric vehicle 1 and at the latter is co-aligned with the charging connector 5 and plugged into the charging connector 5. After completion of the charging process, the charging plug 6 can be automatically extracted or removed from the charging connector 5 again by using the charging device 2.

The charging device 2 can thus be universally used for different electric vehicles 1 because the cable set 3 with the charging plug 6 can be transported to the respective non-standardized position of the charging connector 5 on electric vehicles 1.

For example, the charging connector 5 on the electric vehicle 1 can be provided at the front, on the side or at the rear. The autonomous charging device 2, which is configured as a robotic charger, is in particular configured to automatically move the charging plug 6, for example indirectly by using the drag chain assembly 4, in the direction of an identified charging connector 5 of an electric vehicle 1 to be charged, to co-align it with this charging connector 5, and to introduce it into the latter.

In a simple embodiment, the charging device 2 is specified to move the charging plug 6 automatically to the charging connector 5 only in the transverse direction y and to introduce it into the latter. Alternatively, the charging device 2 can be specified to automatically move the charging plug 6 in the longitudinal direction x, for adjusting the charging plug 6 in the direction of the charging connector 5, and in the transverse direction y, for introducing the charging plug 6 into the charging connector 5. Additionally, the charging device 2 can be specified to automatically move the charging plug 6 in the vertical direction z.

In the illustrated exemplary embodiment according to FIG. 1, the charging device 2 is specified to move the charging plug 6 in the three spatial directions 7.1 to 7.3 in the direction of the charging connector 5. Additionally, the charging plug 6 can be aligned in its angular position at least by way of angle actuators. Furthermore, an additional actuator can be provided, which performs the introduction, in particular the plugging-in, of the charging plug 6 into the charging connector 5.

For this purpose, the drag chain assembly 4 includes for each spatial direction 7.1 to 7.3 in each case an associated drag chain unit 4.1 to 4.3 and the bracket 8 for the charging plug 6, for automatically receiving, in particular gripping, fixing and optionally clearing or releasing the charging plug 6.

A first drag chain unit 4.1 is specified to move the cable set 3 back and forth in the longitudinal direction x. A second drag chain unit 4.2 is specified to move the cable set 3 up and down in the vertical direction z. A third drag chain unit 4.3 is specified to move the cable set 3 back and forth in the transverse direction y.

The third drag chain unit 4.3 can be movably disposed on the second drag chain unit 4.2 or the first drag chain unit 4.1. The second drag chain unit 4.2 can be movably disposed on the first drag chain unit 4.1 or on the third drag chain unit 4.3.

The respective drag chain units 4.1 to 4.3 are disposed and mounted so as to be movable relative to one another.

For example, the second drag chain unit 4.2 is fastened to the first drag chain unit 4.1 so as to be entrained for common adjustment in the longitudinal direction x. The third drag chain unit 4.3 is fastened to the second drag chain unit 4.2 so as to be entrained for an adjustment in the vertical direction z and coupled by way of this second drag chain unit 4.2 so as to be entrained by the first drag chain unit 4.1 for an adjustment in the longitudinal direction x. The third drag chain unit 4.3 is additionally disposed so as to be movable relative to the second drag chain unit 4.2 and to the first drag chain unit 4.1 for an adjustment in the transverse direction y.

The plug bracket 8 is disposed on the third drag chain unit 4.3.

The plug bracket 8 is specified to co-align the charging plug 6 with the charging connector 5 and position the charging plug 6 in relation to the latter. For this purpose, the third drag chain unit 4.3, to which the plug bracket 8 is fastened, is disposed so as to be movable relative to the second drag chain unit 4.2 and to the first drag chain unit 4.1 for an adjustment in the transverse direction y. In particular, the third drag chain unit 4.3 and conjointly with this the in particular rigid or fixed plug bracket 8, is disposed so as to be movable on the second drag chain unit 4.2, for example movable by using separated actuators (not illustrated), for example by using a linear actuator, an angle actuator, a rotary joint, a ball joint, or the like.

The charging plug 6 is still fixedly or rigidly connected to the plug bracket 8. In order to compensate for minor vehicle movements, the plug bracket 8 is specified to release the charging plug 6 in such a way that the latter is plugged into the charging connector 5, on the one hand, and by way of the cable set 3 is flexibly connected to the charging device 2 configured as a charging station, on the other hand.

Preferably, the plug bracket 8 is moved by using the drag chain assembly 4 in the direction of the charging connector 5, and when reaching the longitudinal position of the charging connector 5 is aligned relative to this charging connector 5 in order to then automatically introduce the charging plug 6 into the charging connector 5, or to release or decouple it from the latter.

Optionally, the plug bracket 8 per se can be movably mounted and aligned relative to the charging connector 5 (shown in FIG. 1) and plugged into the charging connector 5 or released or decoupled from the latter.

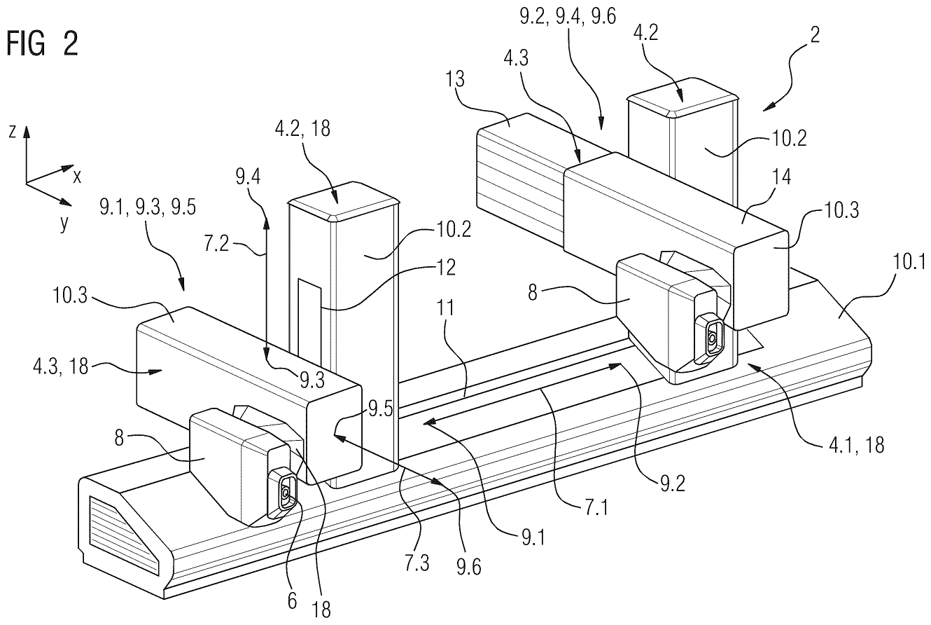

FIG. 2 diagrammatically shows the first embodiment for the charging device 2 shown in FIG. 1 and according to the invention, in a perspective illustration.

FIG. 2 shows the charging device 2 in its two end positions 9.1, 9.2, between which the charging plug 6 can be moved in the first spatial direction 7.1 to any position in the longitudinal direction x. For this purpose, the second drag chain unit 4.2 is adjustable relative to the first drag chain unit 4.1 in the longitudinal direction x, and can be actuated to any position between the two end positions 9.1 and 9.2.

Furthermore, FIG. 2 shows the third drag chain unit 4.3 in its two end positions 9.3 and 9.4, between which the charging plug 6 can be moved to any position in the vertical direction z in the second spatial direction 7.2. For this purpose, the third drag chain unit 4.3 is movable relative to the second drag chain unit 4.2 and to the first drag chain unit 4.1 in the vertical direction z, and can be actuated to any position between the two end positions 9.3 and 9.4.

Moreover, the third drag chain unit 4.3 is illustrated in its two end positions 9.5 and 9.6, between which the charging plug 6 can be moved to any position in the transverse direction y in the third spatial direction 7.3.

Preferably, the plug bracket 8 is moved by using the drag chain assembly 4, conjointly with the charging plug 6 releasably held thereon, in the direction of the charging connector 5 and when reaching the longitudinal position of the charging connector 5 is aligned relative to this charging connector 5 in all three spatial directions 7.1 to 7.3, in order to subsequently automatically introduce the charging plug 6 in the transverse direction y into the charging connector 5, or to release or decouple it from the latter.

Further actuators, in particular angle actuators with additional angular alignment, and linear actuators for introducing the charging plug 6 into the charging connector 5, can be provided for aligning the plug bracket 8 in order to connect the charging plug 6 to the charging connector 5.

Optionally, the plug bracket 8 per se can be movably mounted and aligned relative to the charging connector 5 (shown in FIG. 1) and plugged into the charging connector 5 or released or decoupled from the latter.

The respective drag chain unit 4.1 to 4.3 includes a housing 10.1 to 10.3.

For the longitudinal adjustment of the charging plug 6, this charging plug 6 is disposed so as to be longitudinally adjustable by way of the plug bracket 8, and the latter by way of the movably coupled drag chain units 4.2 and 4.3, in a longitudinal cutout 11 of the housing 10.1 of the first drag chain unit 4.1. In the example shown, the second drag chain unit 4.2 is adjustable in the longitudinal direction x relative to the first drag chain unit 4.1.

For the vertical adjustment of the charging device 2, in particular of the charging plug 6, the third drag chain unit 4.3 is disposed in a vertical cutout 12 of the housing 10.2 of the second drag chain unit 4.2 so as to be vertically adjustable relative to the second drag chain unit 4.2 and the first drag chain unit 4.1 in the vertical direction z.

For the transverse adjustment of the charging device 2, in particular of the charging plug 6, the third drag chain unit 4.3 can additionally be disposed so as to be movable in the transverse direction y relative to the second drag chain unit 4.2 and/or first drag chain unit 4.1. For this purpose, the housing 10.3 can include a transverse cutout in the direction of the second drag chain unit 4.2, in a manner not shown in more detail.

Each of the drag chain units 4.1 to 4.3 can include an associated adjustment device 18, for example a rail system, a guide system with a carriage or the like. The adjustment device 18 can include, for example, linear actuators, angle actuators, rotary joints and/or ball joints. By actuating the adjustment device 18, in particular the linear actuators, angle actuators, rotary joints and/or ball joints, the drag chain units 4.1 to 4.3 can be adjusted independently of one another or depending on one another in/about one or more of the spatial directions 7.1 to 7.3 in a translatory or rotary manner, as a result of which, in turn, the plug bracket 8 fixedly connected to the drag chain unit 4.3 can be moved to the charging plug 6 before a charging operation, during a charging operation and/or after a charging operation, and/or the position of a cleared and plugged charging plug 6 can be traced, and/or the charging plug 6 can be co-aligned with the charging connector 5.

For example, the respective adjustment device 18 can include a stationary unit 13, for example, a fixed rail or a fixed guide or a fixed joint, and a movable unit 14, for example a movable rail or a carriage or a movable joint. The respective adjustment device 18, in particular its movable unit 14, is operatively coupled for motion to a drive (not shown in more detail), in particular a motor, for example an electric motor or the like.

For the transverse adjustment of the charging device 2, in particular of the charging plug 6, the third drag chain unit 4.3 can also be disposed in a multi-part housing 10.3 formed of a stationary housing part and a movable housing part. The movable housing part is coupled to the movable unit 13 of the adjustment device 18 and is movable in the transverse direction y, and thus in the third spatial direction 7.3, relative to the second spatial direction 7.2. The stationary housing part is coupled to the stationary unit 14 of the adjustment device 18. Furthermore, the housing 10.3 is coupled to the second drag chain unit 4.2. For this purpose, the housing 10.3 can include a transverse cutout in the direction of the second drag chain unit 4.2, in a manner not shown in more detail.

Also, the other housings 10.1 and 10.2 of the other spatial directions 7.1 and 7.3 can be configured with multiple parts and, in a manner analogous to that of the housing 10.3, be partially movable by entrainment in a movement of the associated drag chain 18.1 and 18.3, respectively.

FIG. 3 diagrammatically shows in a partially transparent illustration the charging device 2 shown in FIG. 1 and according to the invention in the first end position, with the end positions 9.1, 9.3 and 9.5 of the drag chains 18.1, 18.2 and 18.3, respectively.

The cable set 3 includes at least one charging cable 15 for charging the electric vehicle 1 with direct current or optionally alternating current. Preferably, the charging cable 15 is configured for charging the electric vehicle 1 with direct current or optionally alternating current at a charging current of, for example, at least 200 A or up to several thousand amperes and/or a charging voltage of at least 125 V up to several thousand volts.

In addition to the charging cable 15, the cable set 3 can include a charge transmission cable 16 (also referred to as power cable) and/or electrical auxiliary lines 17, such as at least one control line, a signal line, a measuring line, a power line, a cooling line 22, a supply line or the like.

The drag chain assembly 4 is specified to receive, to guide and to move the cable set 3 in at least one, or a plurality of, or all spatial directions 7.1 to 7.3.

The cable set 3 is routed continuously over a plurality of drag chain units 4.1 to 4.3. Moreover, the plurality of drag chain units 4.1 to 4.3 can in each case be disposed at a mutual spacing in a continuous routing of the cable set 3. In particular, the routing for the cable set 3 can be interrupted in portions by these spacings between the drag chain units 4.1 to 4.3.

In a manner not illustrated in more detail, the cable set 3 can also be of a modular construction. For example, the cable set 3 can have a plurality of cable portions, in particular one cable portion per drag chain unit 4.1 to 4.3. In this instance, two cable portions, for example between two drag chain units 4.1 and 4.2 or 4.2 and 4.3, can be coupled to one another by way of a connection, for example a plug connection.

The respective drag chain unit 4.1 to 4.3 includes an associated drag chain 18.1 to 18.3, in particular for guiding the cable set 3.

The respective drag chain 18.1 to 18.3 can be configured, for example, as a drag hollow section, in particular a drag duct or the like. For example, the charging device 2 can include one associated drag chain 18.1 to 18.3 per spatial direction 7.1 to 7.3. At a cable set end 19 of the cable set 3, the former can be coupled to the charging plug 6, for example by way of a form-locking and/or force-locking connection, in particular a clamping connection, a plug connection or the like. The charging plug 6 in turn is releasably or fixedly disposed on the plug bracket 8, or fixed thereto.

The respective drag chain 18.1 to 18.3 can be configured to be flexible and deflectable. In particular, the respective drag chain 18.1 to 18.3 is flexibly deflectable along its respective longitudinal line, in particular by 180°, or deflectable at a different angle corresponding to the routing in the respective drag chain 18.1 to 18.3. The respective drag chain 18.1 to 18.3 is disposed in the associated housing 10.1 to 10.3.

In a potential refinement, the respective drag chain 18.1 to 18.3 can be configured as a flexible hollow section support and be open, semi-open or closed. A flexible protective jacket, in particular a flexible corrugated tube, a flexible hollow tube, a flexible corrugated hose or the like, can be provided for the protection of the cables in portions of the cable set 3 that are without a drag chain. The cable set 3, in particular the charge transmission cable 16, the charging cable 15 and/or the auxiliary lines 17 (also referred to as ancillary lines), can be received in the hollow section support or in the flexible protective jacket at least over a part of their length and/or in portions, so as to be inside the hollow section support or the protective jacket.

In addition, the respective drag chain 18.1 to 18.3 at one or both ends can in each case be provided with a strain relief unit 20 for the respective cable of the cable set 3, in particular the respective charge transmission cable 16, the charging cable 15 and/or the auxiliary lines 17.

In a transition 21 between two of the spatial directions 7.1 to 7.3, for example between the spatial directions 7.1 and 7.2, 7.2 and 7.3 and 7.3 and 7.1 respectively, the drag chain assembly 4 is without a drag chain and thus formed without a hollow section support. These transitions 21 without drag chains can be provided with an additional protection by routing the cable set 3 in a flexible corrugated tube, a flexible corrugated hose or the like.

In the first exemplary embodiment, the cable set 3 is formed from a plurality of stranded copper wires. In particular, the cable set 3 can include a plurality of flexural stranded copper wires. In particular, the stranded copper wires can be configured as flexible individual lines. Due to the use of stranded copper wires in the respective drag chain 18.1 to 18.3 as the cable set 3, the cable cross section can be selected accordingly in such a way that the electrical losses are as low as possible. One or a plurality of stranded copper wires can be used to transport electricity. Highly flexible stranded copper wires are particularly advantageous, whereby the installation space and thus the respective drag chain 18.1 to 18.3 can be optimized due to the small bending radius.

In particular, each individual cable, for example, the charging cable 15, in particular each individual pole cable, of the cable set 3 can be formed from a plurality of flexible strands, in particular stranded copper wires. The overall cross section of the cable set 3 can be easily adapted to the output class of the autonomous charging device 2 by using a plurality of strands for a cable.

Depending on the type of charging device 2, for example high-performance charging device, and the cross section of the stranded copper wires, one or a plurality of cooling lines 22 can be additionally provided for cooling the cable set 3, the charging cable and/or the charging plug 6.

The plug bracket 8 can be configured, for example, as a gripping arm, a gripping hook or a carrying hook, so as to automatically grip and hold/fix the charging plug 6, in particular in the displaced state or after a charging operation, or optionally release and loosen the charging plug 6 during a charging operation.

In addition, the respective drag chain 18.1 to 18.3 can be able to be driven and moved by using at least one drive assembly 23. The drive assembly 23 can include in each case, for example, one associated linear drive for each spatial direction 7.1 to 7.3.

The respective linear drive can in particular include a linear adjustment unit 24.1 to 24.3, and an associated drive unit, in particular a motor (not shown in more detail). For example, the linear adjustment unit 24.1 to 24.3 includes in each case the stationary unit 13, for example a stationary base unit or a stationary rail, and the movable unit 14, in particular a carriage or a movable rail. Instead of linear drives, or in addition to these, other drive types with other adjustment units, in particular multi-dimensionally movable adjustment units, such as angle actuators, rotary joints or the like, which perform additionally required rotational movements can also be used, for example.

In this instance, the respective motor is coupled in a manner not illustrated in more detail to the linear adjustment unit 24.1 to 24.3 in order to move the latter according to the associated spatial direction 7.1 to 7.3. Depending on the embodiment of the drive, the latter can be disposed on the stationary unit 13 or the movable unit 14.

In another embodiment, the respective drag chain 18.1 to 18.3 is disposed parallel to the respective linear adjustment unit 24.1 to 24.3. For example, the respective drag chain 18.1 to 18.3 is fastened to the stationary unit 13 on the one side, and to the portable unit 14 on the other, to be entrained thereby.

FIG. 4 diagrammatically shows the charging device 2 according to the invention, in particular the first drag chain unit 4.1 and the associated drag chain 18.1, in the end position 9.2 in the longitudinal direction x, and the second drag chain unit 4.2 and the associated drag chain 18.2 in the end position 9.4 in the vertical direction z, and the third drag chain unit 4.3 and the associated drag chain 18.3 in the end position 9.6 in the transverse direction y. In other words: The respective drag chain 18.1 to 18.3 is in each case shown in its deployed end position 9.2, 9.4 and 9.6, respectively.

In FIG. 3, the charging device 2 according to the invention, in particular the respective drag chain 18.1 to 18.3, is shown in the associated retracted end position 9.1 to 9.3 in the longitudinal direction x, and in the transverse direction y, and in the vertical direction z.

FIG. 5 diagrammatically shows a second exemplary embodiment for a charging device 2′ according to the invention, in a perspective illustration.

The charging device 2′ according to FIGS. 5 to 7 differs from the charging device 2 according to FIGS. 1 to 4 in that the cable set 3 is formed from an outer flexible cable portion which includes an external charging cable 26 without a drag chain, and from an inner cable portion which carries signal lines, supply lines, protective lines, power transport lines or the like. The inner cable set 3 is guided in the drag chain assembly 4.

The ancillary lines, signal lines and/or the charge transmission cables 16 of the inner cable portion configured as power transport lines are guided and moved only partially or in portions by using the previously described drag chains 18.1 to 18.3 of the drag chain units 4.1 to 4.3. The other lines and/or the power transport lines are, for example, configured as strands, in particular stranded copper wires, as described above.

The cross section and scope of the power transport lines can be adapted to predefined output requirements. By virtue of such a configuration, the cable set 3 can be guided as far as possible without cooling and with low losses by using the drag chain assembly 4. Only the region of the external charging cable 26 with the smaller cross section or circumference and the charging plug 6 need to be cooled. The spatial direction 7.1 to 7.3 and/or position from which the charging cable 15 is routed freely and externally, and correspondingly to which point the routing is performed in drag chains 18.1 to 18.3 and the use of power transport cables takes place, can be selected according to requirements.

Thus, the relevant transition 21 from the guided charge transmission cables 16 (=guided power transport lines) to the free charging cable 15 can be flexibly selected and adapted accordingly to the requirements. The charging device 2, in particular its charge transmission cable 16, can thus be configured for different output classes. The charging cable 15, optionally partly lying free on the outside, and the charging plug 6 can be selected according to the output class.

Both charging devices 2, 2′ can each be provided with a camera 27 in the plug bracket 8. The camera 27 can be disposed above the charging plug 6 or in the region of the latter, for example. The camera 27 can be directed toward a possible charging connector 5 for an electric vehicle 1 to be charged (as illustrated in FIG. 1).

In this instance, the camera 27, both when feeding the charging plug 6 by using the previously described drag chain assembly 4 in the direction of charging connector 5 and when charging, and thus in the plugged state of the charging plug 6 in the charging connector 5, can be specified to monitor the charging plug 6, the coupling of the charging plug 6 and the charging connector 5, in particular to find the position of the charging connector 5, to track the charging plug 6 and/or to track a possible movement of the electric vehicle 1 (illustrated in FIG. 1).

FIG. 6 diagrammatically shows the alternative charging device 2′ according to FIG. 5 in a view from above and in the first end position 9.1, i.e. the retracted position.

FIG. 7 diagrammatically shows the alternative charging device 2′ according to FIG. 5 in a lateral view with the drag chain units 4.1 to 4.3 and the plug bracket 8, and the external charging cable 26 between the plug bracket 8 and the third drag chain unit 4.3.

While the invention has been illustrated and described in more detail by referring to preferred exemplary embodiments, the invention is not limited by the disclosed examples and other variations may be derived therefrom by a person skilled in the art without departing from the scope of protection of the invention.

The following is a summary list of reference numerals and the corresponding structure used in the above description of the invention:
1 Electric vehicle
2,2′ Charging device
3 Set of cables (cable set)
4 Drag chain assembly
4.1 to 4.3 Drag chain unit
5 Charging connector
6 Charging plug
7.1 to 7.3 Spatial direction
8 Plug bracket
9.1 to 9.6 End position
10.1 to 10.3 Housing
11 Longitudinal cutout
12 Vertical cutout
13 Stationary unit
14 Mobile unit
15 Charging cable
16 Charge transmission cable
17 Auxiliary line
18.1 to 18.3 Drag chain
19 Cable set end
20 Strain relief unit
21 Transition
22 Cooling line
23 Drive assembly
24.1 to 24.3 Linear adjustment unit
26 External charging cable
27 Camera
x Longitudinal direction
y Transverse direction
z Vertical direction

1. A charging device for charging an electric vehicle with electrical energy, the charging device comprising:
a charging cable configured to be connected to a charging connector of the electric vehicle to be charged;
a set of cables;
a drag chain assembly configured to transport said set of cables flexibly in a direction of the charging connector of the electric vehicle in at least one spatial direction and to co-align said set of cables with the charging connector of the electric vehicle.

2. The charging device according to claim 1, wherein said set of cables includes at least one of a charging cable or a charge transmission cable or a power transport line or an electrical auxiliary line, and said drag chain assembly is configured to receive, guide and move said set of cables.

3. The charging device according to claim 1, wherein said drag chain assembly is configured to guide and move said set of cables in a plurality of spatial directions.

4. The charging device according to claim 2, wherein said drag chain assembly is configured to guide and move said set of cables in a plurality of spatial directions.

5. The charging device according to claim 1, wherein said drag chain assembly includes at least one of:
at least one drag chain for guiding said set of cables, or
at least one plug bracket for entraining a charging plug.

6. The charging device according to claim 5, which further comprises at least one drive assembly for moving said at least one drag chain.

7. The charging device according to claim 6, wherein said at least one drive assembly includes a linear adjustment unit, and said at least one drag chain is disposed parallel to said linear adjustment unit.

8. The charging device according to claim 5, wherein said drag chain assembly is configured to cool said charging cable and said charging plug.

9. The charging device according to claim 5, wherein said at least one drag chain is configured to be flexible and deflectable.

10. The charging device according to claim 5, wherein said at least one drag chain is configured as a flexible hollow section support in which said set of cables is received at least in portions.

11. The charging device according to claim 1, wherein said set of cables is guided without drag chains in a transition between two spatial directions.

12. The charging device according to claim 2, wherein said charging cable includes a plurality of stranded copper wires.

13. The charging device according to claim 12, wherein said plurality of stranded copper wires are configured as flexible individual lines and are at least one of installation space-optimized or configured depending on an output class.

14. The charging device according to claim 5, which further comprises at least one strain relief element, said at least one drag chain having at least one end, and said set of cables being fastened to said at least one end of said at least one drag chain by said at least one strain relief element.
